(19) United States
(12) Patent Application Publication
(10) Pub. No.: US 2011/0318620 A1
(43) Pub. Date: Dec. 29, 2011

(54) RECHARGEABLE BATTERY

(75) Inventors: Kwi-Seok CHOI, Yongin-si (KR); Ki-Jun KIM, Yongin-si (KR); Myung-Duk LIM, Yongin-si (KR); Ihn KIM, Yongin-si (KR)

(73) Assignee: SAMSUNG SDI CO., LTD., Yongin-si (KR)

(21) Appl. No.: 13/076,679

(22) Filed: Mar. 31, 2011

(30) Foreign Application Priority Data
Jun. 28, 2010 (KR) 10-2010-0061340

(51) Int. Cl. H01M 10/36; H01M 10/02; H01M 2/02

(52) U.S. Cl. 429/94; 429/163; 429/153

(57) ABSTRACT

A rechargeable battery including an electrode assembly that includes a positive electrode and a negative electrode and a separator and is configured of any one of a winding type and a stacking type and a case receiving the electrode assembly together with an electrolyte solution. A positive electrode includes a positive current collector and a negative electrode includes a negative current collector. At least one of a positive current collector and a negative current collector is positioned at a base layer to which an active material is applied and protruding portions that are positioned at one end of the base layer and are formed at a larger thickness than the base layer to surface-contact each other at the wound or stacked electrode assembly.

### CLAIM OF PRIORITY

This application makes reference to, incorporates the same herein, and claims all benefits accruing under 35 U.S.C. §119 from an application earlier filed in the Korean Intellectual Property Office on Jun. 28, 2010 and there duly assigned Serial No. 10-2010-0061340.

### BACKGROUND OF THE INVENTION

1. Field of the Invention

The general inventive concept relates to a rechargeable battery.

2. Description of the Related Art

A rechargeable battery is a battery that can be recharged, unlike a primary battery that cannot be recharged. A low-capacity rechargeable battery is used for portable small electronic devices such as cellular phones, notebook computers, and camcorders and a large-capacity rechargeable battery has been used as a power supply for driving a motor for a hybrid car, etc.

The above information disclosed in this Related Art section is only for enhancement of understanding of the background of the described technology and therefore it may contain information that does not form the prior art that is already known in this country to a person of ordinary skill in the art.

### SUMMARY OF THE INVENTION

Aspects of the present invention have been made in an effort to provide an electrode assembly capable of increasing capacity and improving output by lowering resistance of a positive current collector and negative current collector and a rechargeable battery using the same.

Aspects of the present invention provide for a rechargeable battery including: an electrode assembly including a positive electrode, a negative electrode, and a separator; and a case receiving the electrode assembly together with an electrolyte solution. The positive electrode includes a positive current collector on which a positive active material layer is coated and the negative electrode includes a negative current collector to which a negative active material layer is coated. At least one of the positive current collector and the negative current collector includes a protruding portion that is positioned at a base layer and one end of the base layer and has a larger thickness than the base layer.

The positive current collector may include a positive base layer and a positive protruding portion and the negative current collector includes a negative base layer and a negative protruding portion, and the positive protruding portion and the negative protruding portion may be positioned to face each other

The positive active material layer may be formed on at least one surface of the positive base layer and the negative active material layer may be formed on at least one surface of the negative base layer.

The electrode assembly may be formed by being wound after the positive electrode, the separator, and the negative electrode are stacked. The positive protruding portion may be formed in parallel with the length direction of the positive electrode and the negative protruding portion may be formed in parallel with the length direction of the negative electrode.

The positive protruding portions may surface-contact each other along the thickness direction of the positive electrode in the wound electrode assembly and the negative protruding portions may surface-contact each other along the thickness direction of the negative electrode in the wound electrode assembly.

The protruding height of the positive protruding portion may be set to 1 to 1.2 times larger than a distance between the positive base layers measured along the thickness direction of the positive electrode after the electrode assembly is wound. The protruding height of the negative protruding portion may be set to 1 to 1.2 times larger than a distance between the negative base layers measured along the thickness direction of the negative electrode after the electrode assembly is wound.

The electrode assembly may be formed by repeatedly stacking the positive electrode, the separator, the negative electrode, and the separator. The positive protruding portion may surface-contact each other along the thickness direction of the electrode assembly in the stacked electrode assembly and the negative protruding portion may surface-contact each other along the thickness direction of the electrode assembly in the stacked electrode assembly.

The electrode assembly may include a first adhesive tape that is attached to the positive protruding portions to fix the positive protruding portions and a second adhesive tape that is attached to the negative protruding portions to fix the negative protruding portions.

The protruding height of the positive protruding portion may be set to 1 to 1.2 times larger than a distance between the positive base layers measured along the thickness direction of the positive electrode after the electrode assembly is stacked. The protruding height of the negative protruding portion may be set to 1 to 1.2 times larger than a distance between the negative base layers measured along the thickness direction of the negative electrode after the electrode assembly is stacked.

Another aspect of the present invention provides for a rechargeable battery, including: an electrode assembly that includes a positive electrode and a negative electrode and a separator and is configured of any one of a winding type and a stacking type; and a case receiving the electrode assembly together with an electrolyte solution. The positive electrode includes a positive current collector and the negative electrode includes a negative current collector. At least one of the positive current collector and the negative current collector is positioned at a base layer to which an active material is applied and protruding portions that are positioned at one end of the base layer and are formed at a larger thickness than the base layer to surface-contact each other at the wound or stacked electrode assembly.

According to another aspect of the present invention, in the wound electrode assembly or the stacked electrode assembly, the positive protruding portions surface-contact each other and the negative protruding portions surface-contacts each other, thereby making it possible to lower the resistance of the positive current collector and the negative current collector. As a result, the present invention lowers the resistance of the positive current collector and the negative current collector without degrading the capacity of the rechargeable battery, thereby making it possible to improve the output characteristics of the rechargeable battery.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cutout perspective view of a rechargeable battery according to a first exemplary embodiment;

FIG. 2 is an exploded perspective view showing a state before an electrode assembly in a rechargeable battery is wound shown in FIG. 1;

FIG. 3 is a partially enlarged view of a positive electrode and a negative electrode shown in FIG. 2;

FIG. 4 is an exploded perspective view of a rechargeable battery according to a second exemplary embodiment;

FIG. 5 is a cross-sectional view of a coupling state of a rechargeable battery shown in FIG. 4;

FIG. 6 is a partially cut-out perspective view of a rechargeable battery according to a third exemplary embodiment; and

FIG. 7 is a cross-sectional view of an electrode assembly in a rechargeable battery shown in FIG. 6.

### DETAILED DESCRIPTION OF THE INVENTION

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Generally, a rechargeable battery includes an electrode assembly, a case receiving an electrode assembly, and a cap assembly encapsulating the case and electrically connected to the electrode assembly. The electrode assembly is configured to include a positive electrode, a negative electrode, and a separator disposed between the positive electrode and the negative electrode.

The positive electrode includes a positive current collector and a positive active material layer applied to the positive current collector and the negative electrode includes the negative current collector and the negative active material layer applied to the negative current collector. The positive current collector and the negative current collector are made of metal such as copper or aluminum, etc., and serves as an electrode supporting the corresponding active material layer and transporting charges.

In order to maximize the capacity of the rechargeable battery, the positive current collector and the negative current collector should be thinly manufactured and the volume of the positive active material layer and the negative active material layer should be increased. However, the resistance of the positive current collector and the negative current collector transporting charges is increased, such that the output of the rechargeable battery is reduced.

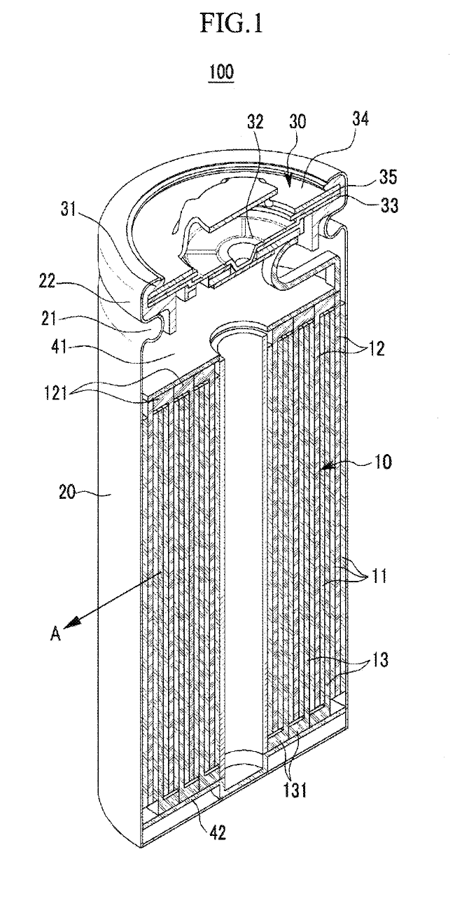

FIG. 1 is a cutout perspective view of a rechargeable battery according to a first exemplary embodiment.

Referring to FIG. 1, a rechargeable battery 100 of a first exemplary embodiment includes an electrode assembly 10, a case 20 receiving the electrode assembly 10 together with an electrolyte solution, and a cap assembly 30 encapsulating the case 20. The electrode assembly 10 may include a positive electrode 12 and a negative electrode 13, putting a separator 11 therebetween. One end of the case 20 is provided with an opening and a cap assembly 30 is mounted on the opening of the case 20, putting a gasket therebetween.

The case 20 may have a cylindrical shape of which inner space is formed with the electrode assembly 10. The case 20 may be made of a conductive metal, such as aluminum, aluminum alloy, or nickel-plated steel. The cap assembly 30 is inserted into the case 20 and then, fixed by a clamping pressure. During this process, the case 20 is formed with a recess portion 21 and a fastening portion 22. Contained within the fastening portion 22 is a gasket 31.

The cap assembly 30 may include various members in order to improve the safety of the rechargeable battery 100. For example, the cap assembly 30 may be provided with a vent plate 33 having a notch 32 that is broken at a predetermined pressure condition and discharges gas. The vent plate 33 serves to electrically disconnect the electrode assembly 10 to an external terminal, a cap up 34 at a predetermined pressure condition.

Further, the cap assembly 30 may be provided with a positive temperature coefficient element 35. The positive temperature coefficient element 35, which is a member whose electrical resistance becomes infinite at the time of exceeding a predetermined temperature, serves to block current when the rechargeable battery 100 overheats to a temperature of a predetermined value or more. The shape of the assembly 30 is not limited to the illustrated example and therefore, can be variously changed.

The electrode assembly 10 has a cylindrical shape corresponding to the shape of the case 20. To this end, the positive electrode 12 and the negative electrode 13 are stacked, putting the separator 11 therebetween and then, are wound round based on a winding shaft and are received in the case 20 together with the electrolyte solution. The upper end 121 of the positive electrode 12 is protruded to the outside of the separator 11 to be electrically connected to a positive current collector 41. The lower ends 131 of the negative electrode 13 are protruded to the outside of the separator 11 to be electrically connected to the negative current collector 42.

The upper ends 121 of the wound positive electrode 12 in the rechargeable battery 100, according to the first exemplary embodiment, surface-contact each other along the thickness direction (see arrow A) of the positive electrode 12. The lower ends 131 of the wound negative electrode 13 also surface-contacts each other along the thickness direction (see arrow A) of the negative electrode 13. In this configuration, the thickness direction conforms to the radial direction that proceeds from the center of the electrode assembly 10 toward the outside thereof

In other words, in the upper end 121 of the positive electrode 12, an n-th wound portion from the winding shaft contacts an n−1-th wound portion and an n+1-th wound portion, such that they are conducted with each other. In the lower end 131 of the cathode 13, a m-th wound portion from the winding shaft contacts a m−1-th wound portion and a m+1-th wound portion, such that they are conducted with each other. In this configuration, the positive upper end 121 and the negative lower end 131 are a non-coated portion where active material is not applied.

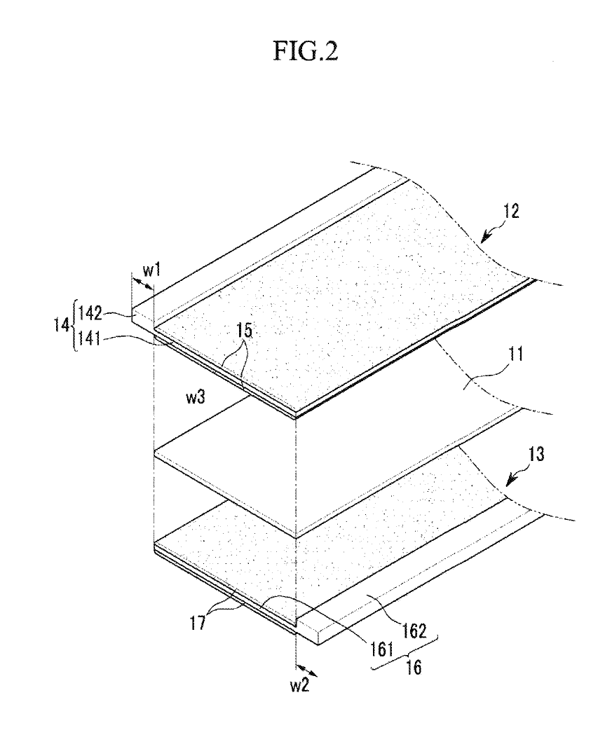

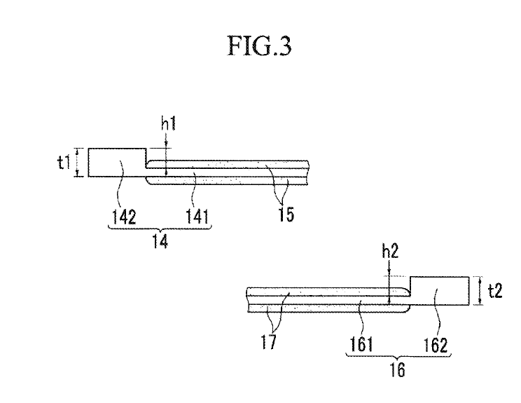

FIG. 2 is an exploded perspective view showing a state before an electrode assembly in a rechargeable battery is wound shown in FIG. 1 and FIG. 3 is a partially enlarged view of a positive electrode and a negative electrode shown in FIG. 2.

Referring to FIGS. 1 to 3, the positive electrode 12 includes a positive current collector 14 and an active material layer 15 applied to the positive current collector 14. The positive current collector 14 includes a positive base layer 141 and a positive protruding portion 142 that is positioned at one end of the positive base layer 141 and has a larger thickness than the positive base layer 141. The positive active material layer 15 is applied to one surface or both surfaces of the positive base layer 141.

The positive protruding portion 142 is positioned in parallel with a length direction of the positive electrode 12 and has a predetermined width (w1, see FIG. 2) and a predetermined thickness (t1, see FIG. 3). The positive protruding portion 142 is a non-coated portion where positive active material is not applied.

The cathode 13 includes a negative current collector 16 and a negative active material layer 17 that is coated on the negative current collector 16. The negative current collector 16 includes a negative base layer 161 and a negative protruding portion 162 that is positioned at one end of the negative base layer 161 and has a larger thickness than the negative base layer 161. The negative active material layer 17 is applied to one surface or both surfaces of the negative base layer 161.

The negative protruding portion 162 is positioned in parallel with a length direction of the negative electrode 13 and has a predetermined width (w2, see FIG. 2) and a predetermined thickness (t2, see FIG. 3). The negative protruding portion 162 is a non-coated portion where negative active material is not applied. The positive protruding portion 142 and the negative protruding portion 162 may have the same width and thickness.

FIG. 2 shows the case where the positive active material layer 15 is formed on both surface of the positive base layer 141 and the negative active material layer 17 is formed on the negative base layer 161.

The separator 11 has a smaller width than the positive electrode 12 and the negative electrode 13 and is positioned between the positive base layer 141 and the negative base layer 161 not to be overlapped with the positive protruding portion 142 and negative protruding portion 162. In this configuration, the positive protruding portion 142 and the negative protruding portion 162 are positioned to face each other.

Therefore, the positive protruding portion 142 becomes the positive upper end 121 shown in FIG. 1 and the negative protruding portion 162 becomes the negative lower end 131 shown in FIG. 1. The positive electrode 12 and the negative electrode 13 and the separator 11 are wound in a cylindrical shape and is fixed by an adhesive tape (not shown) not to be released.

In the wound electrode assembly 10, the positive protruding portions 142 surface-contact each other along the length direction (winding direction) of the positive electrode 12, thereby making it possible to effectively lower the resistance of the positive current collector 14. Further, in the wound electrode assembly 10, the negative protruding portions 162 surface-contact each other along the length direction (winding direction) of the negative electrode 13, thereby making it possible to effectively lower the resistance of the negative current collector 16. Therefore, the rechargeable battery 100 of the first exemplary embodiment can improve the output characteristics.

The protruding height (h1, see FIG. 3) of the positive protruding portion 142 (h1, see FIG. 3) may be set to 1 to 1.2 times larger than a distance between the positive base layers 141 measured along the thickness direction of the positive electrode 12 after the electrode assembly 10 is wound. If the protruding height h1 of the positive protruding portion 142 is less than 1 times smaller than the distance between the positive base layers 141, the positive protruding portions 142 cannot surface-contact each other after the electrode assembly 10 is wound and if the protruding height h1 of the positive protruding portion 142 exceeds 1.2 times of the distance between the positive base layers 141, the adhesion between the positive base layer 141 and the separator 11 is degraded, such that the battery performance can be degraded.

The protruding height (h2, see FIG. 3) of the negative protruding portion 162 may be set to 1 to 1.2 times larger than a distance between the negative base layers 161 measured along the thickness direction of the negative electrode 13 after the electrode assembly 10 is wound. If the protruding height h2 of the negative protruding portion 162 is less than 1 times smaller than the distance between the negative base layers 141, the negative protruding portions 162 cannot surface-contact each other after the electrode assembly 10 is wound and if the protruding height h2 of the negative protruding portion 162 exceeds 1.2 times of the distance between the positive base layers 141, the adhesion between the negative base layer 161 and the separator 11 is degraded, such that the battery performance can be degraded.

When the positive active material layer 15 and the negative active material layer 17 are each formed on both surfaces of the positive base layer 141 and the negative base layer 161, the distance between the positive base layers 141 approximately meets the sum of the thickness of two separators 11, the thickness of two positive active material layers 15, the thickness of the negative active material layers 17, and the thickness of the negative base layer 161 after the electrode assembly 10 is wound. After the electrode assembly 10 is wound, the distance between the negative base layers 161 approximately meets the sum of the thickness of two separators 11, the thickness of two positive active material layers 15, the thickness of two negative active material layers 17, and the thickness of positive base layer 141.

When the positive active material layer 15 and the negative active material layer 17 are each formed on one surface of the positive base layer 141 and the negative base layer 161, the distance between the positive base layers 141 approximately meets the sum of the thickness of two separators 11, the thickness of two positive active material layers 15, the thickness of the negative active material layers 17, and the thickness of the negative base layer 161 after the electrode assembly 10 is wound. After the electrode assembly 10 is wound, the distance between the negative base layers 161 approximately meets the sum of the thickness of two separators 11, the thickness of positive active material layers 15, the thickness of negative active material layer 17, and the thickness of positive base layer 141.

Although the exemplary embodiment describes the case where each protruding portion 142 and 162 is formed at both of the positive current collector 14 and the negative current collector 16, a configuration where the protruding portion is formed at any one of the positive current collector 14 and the negative current collector 16 can be also permitted.

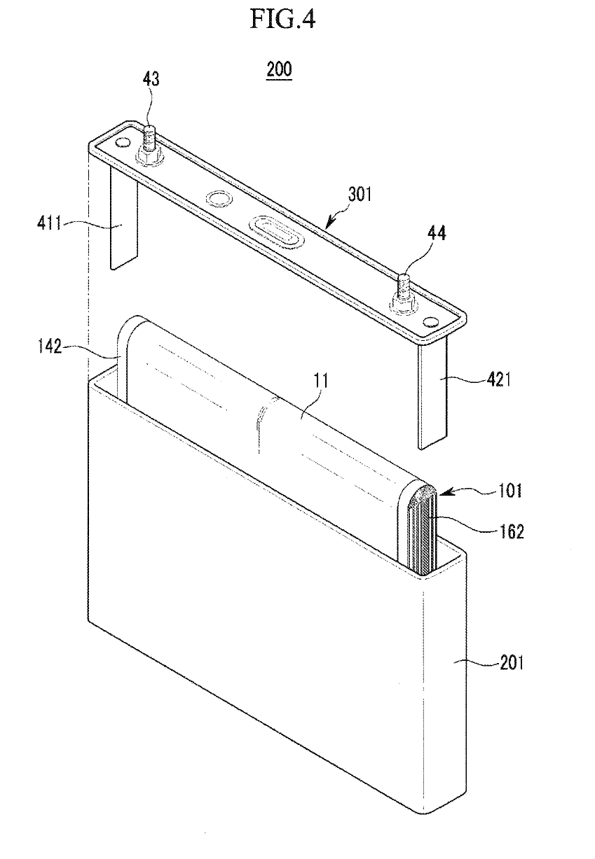

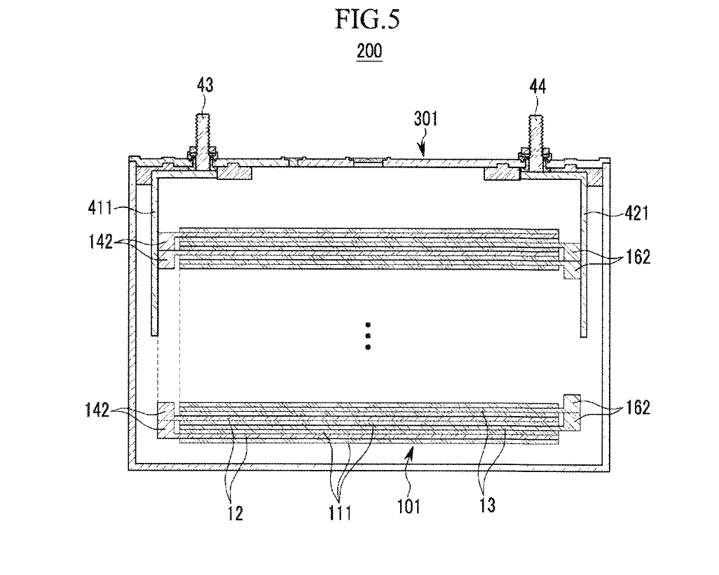

FIG. 4 is an exploded perspective view of a rechargeable battery according to a second exemplary embodiment and FIG. 5 is a cross-sectional view of a coupling state of a rechargeable battery shown in FIG. 4.

Referring to FIGS. 4 and 5, in a rechargeable battery 200 according to a second exemplary embodiment, an electrode assembly 101 has the same configuration as the electrode assembly of the first exemplary embodiment, except that the electrode assembly is pressed to be flat like a plate shape after being wound. Like members are denoted by like reference numerals as in the first exemplary embodiment.

A case 201 is formed in a quadrangular shape corresponding to the shape of the electrode assembly 101 and receives the electrode assembly 101 together with the electrolyte solution. The cap assembly 301 is mounted on the opening of the case 201 to encapsulate the case 201. In FIG. 2, reference numeral 411 shows a positive current collector and reference numeral 421 shows a negative current collector. Reference numeral 43 is a positive terminal connected to the positive current collector 411 and reference numeral 44 is a negative terminal connected to a negative current collector 421.

The rechargeable battery 200 of the second exemplary embodiment forms the positive protruding portion 142 and the negative protruding portion 162 in the positive electrode 12 and the negative electrode 13, respectively, as in the rechargeable battery according to the rechargeable battery of the above-mentioned first exemplary embodiment to lower the resistance of the positive current collector and the negative current collector, thereby making it possible to improve the output characteristics of the rechargeable battery 200.

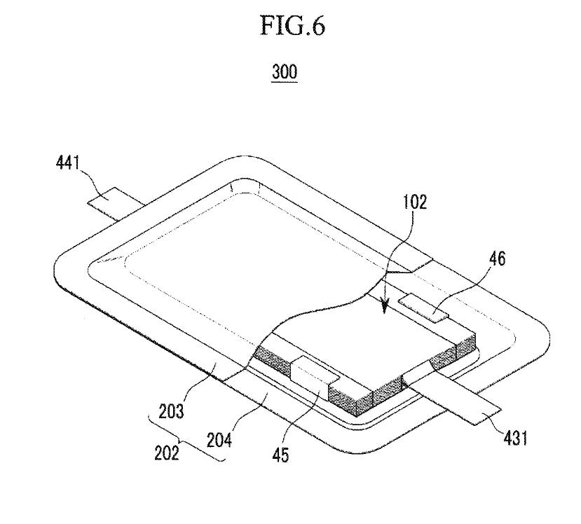

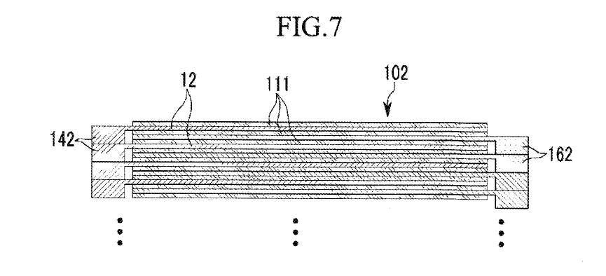

FIG. 6 is a partially cut-out perspective view of a rechargeable battery according to a third exemplary embodiment and FIG. 7 is a cross-sectional view of an electrode assembly in a rechargeable battery shown in FIG. 6.

Referring to FIG. 6 and FIG. 7, in a rechargeable battery 300 according to a third exemplary embodiment, an electrode assembly 102 has the same configuration as the electrode assembly of the first exemplary embodiment, except that the positive electrode 12, the negative electrode 13, and the separator 11 are provided in plural and the separator 11, the positive electrode 12, the separator 11, and the negative electrode 13 are repeatedly stacked in this sequence. In the stacking sequence, the positive electrode 12 may be replaced with the negative electrode 13 and the negative electrode 13 may be replaced with the positive electrode 12.

The case 202 may include an upper case 203 and a lower case 204 whose centers are formed concavely. The upper case 203 an the lower case 204 may be manufactured as a laminate sheet and the electrode assembly 102 in which the electrolyte solution is impregnated is received in the inner space and then, the edges thereof are integrally bonded by thermal bonding to close the electrode assembly 102. A positive terminal 431 electrically connected to the positive electrode 12 and a negative terminal 441 electrically connected to the negative electrode 13 are drawn out to the outside of the case 202.

Each positive electrode 12 forms the positive protruding portion 142 at one end thereof such that the plurality of positive protruding portions 142 surface-contact each other along the thickness direction of the electrode assembly 102. Each negative electrode 13 forms the negative protruding portion 162 at one end thereof such that the plurality of negative protruding portions 162 surface-contact each other along the thickness direction of the electrode assembly 102. The positive protruding portion 142 and the negative protruding portion 162 are positioned to face each other.

The electrode assembly 102 may include a first adhesive tape 45 that is attached to the positive protruding portions 142 to fix the positive protruding portions 142 and a second adhesive tape 46 that is attached to the negative protruding portions 162 to fix the negative protruding portions 162. The positive protruding portions 142 and the negative protruding portions 162 can firmly keep the surface-contact state by the first and second adhesive tapes 45 and 46.

Likewise the rechargeable battery of the above-mentioned first and the second exemplary embodiments, the rechargeable battery 300 according to the third exemplary embodiment forms the positive protruding portion 142 and the negative protruding portion 162 in the positive electrode 12 and the negative electrode 13, respectively, to lower the resistance of the positive current collector and the negative current collector, thereby making it possible to improve the output characteristics of the rechargeable battery.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery, comprising:
an electrode assembly including a positive electrode, a negative electrode, and a separator; and
a case receiving the electrode assembly together with an electrolyte solution
the positive electrode includes a positive current collector on which a positive active material layer is coated and the negative electrode includes a negative current collector to which a negative active material layer is coated,
at least one of the positive current collector and the negative current collector includes a protruding portion that is positioned at a base layer and one end of the base layer and has a larger thickness than the base layer.

2. The rechargeable battery of claim 1, wherein:
the positive current collector includes a positive base layer and a positive protruding portion and the negative current collector includes a negative base layer and a negative protruding portion, and
the positive protruding portion and the negative protruding portion are positioned to face each other.

3. The rechargeable battery of claim 2, wherein:
the positive active material layer is formed on at least one surface of the positive base layer and the negative active material layer is formed on at least one surface of the negative base layer.

4. The rechargeable battery of claim 2, wherein:
the electrode assembly is formed by being wound after the positive electrode, the separator, and the negative electrode are stacked.

5. The rechargeable battery of claim 4, wherein:
the positive protruding portion is formed in parallel with the length direction of the positive electrode and the negative protruding portion is formed in parallel with the length direction of the negative electrode.

6. The rechargeable battery of claim 5, wherein:
the positive protruding portions surface-contact each other along the thickness direction of the positive electrode in the wound electrode assembly and the negative protruding portions surface-contact each other along the thickness direction of the negative electrode in the wound electrode assembly.

7. The rechargeable battery of claim 6, wherein:
the protruding height of the positive protruding portion is set to 1 to 1.2 times larger than a distance between the positive base layers measured along the thickness direction of the positive electrode after the electrode assembly is wound.

8. The rechargeable battery of claim 6, wherein:
the protruding height of the negative protruding portion is set to 1 to 1.2 times larger than a distance between the negative base layers measured along the thickness direction of the negative electrode after the electrode assembly is wound.

9. The rechargeable battery of claim 2, wherein:
the electrode assembly is formed by repeatedly stacking the positive electrode, the separator, the negative electrode, and the separator.

10. The rechargeable battery of claim 9, wherein:
the positive protruding portion surface-contact each other along the thickness direction of the electrode assembly in the stacked electrode assembly and the negative protruding portion surface-contact each other along the thickness direction of the electrode assembly in the stacked electrode assembly.

11. The rechargeable battery of claim 10, wherein:
the electrode assembly includes a first adhesive tape that is attached to the positive protruding portions to fix the positive protruding portions and a second adhesive tape that is attached to the negative protruding portions to fix the negative protruding portions.

12. The rechargeable battery of claim 10, wherein:
the protruding height of the positive protruding portion is set to 1 to 1.2 times larger than a distance between the positive base layers measured along the thickness direction of the positive electrode after the electrode assembly is stacked.

13. The rechargeable battery of claim 10, wherein:
the protruding height of the negative protruding portion is set to 1 to 1.2 times larger than a distance between the negative base layers measured along the thickness direction of the negative electrode after the electrode assembly is stacked.

14. A rechargeable battery, comprising:
an electrode assembly that includes a positive electrode and a negative electrode and a separator and is configured of any one of a winding type and a stacking type; and
a case receiving the electrode assembly together with an electrolyte solution,
the positive electrode include a positive current collector and the negative electrode includes a negative current collector,
at least one of the positive current collector and the negative current collector positioned at a base layer to which an active material is applied and protruding portions that are positioned at one end of the base layer and are formed at a larger thickness than the base layer to surface-contact each other at the wound or stacked electrode assembly.

15. The rechargeable battery of claim 14, wherein:
the electrode assembly is formed by repeatedly stacking the positive electrode, the separator, the negative electrode, and the separator.

16. The rechargeable battery of claim 15, wherein:
the positive protruding portion surface-contact each other along the thickness direction of the electrode assembly in the stacked electrode assembly and the negative protruding portion surface-contact each other along the thickness direction of the electrode assembly in the stacked electrode assembly.

17. The rechargeable battery of claim 16, wherein:
the electrode assembly includes a first adhesive tape that is attached to the positive protruding portions to fix the positive protruding portions and a second adhesive tape that is attached to the negative protruding portions to fix the negative protruding portions.

18. The rechargeable battery of claim 16, wherein:
the protruding height of the positive protruding portion is set to 1 to 1.2 times larger than a distance between the positive base layers measured along the thickness direction of the positive electrode after the electrode assembly is stacked.

19. The rechargeable battery of claim 16, wherein:
the protruding height of the negative protruding portion is set to 1 to 1.2 times larger than a distance between the negative base layers measured along the thickness direction of the negative electrode after the electrode assembly is stacked.

20. The rechargeable battery of claim 16, wherein:
the protruding height of the positive protruding portion and the protruding height of the negative protruding portion is set to 1 to 1.2 times larger than a distance between either the positive base layers or the negative base layers measured along the thickness direction of the negative electrode after the electrode assembly is stacked.
